(19) United States
(12) Patent Application Publication
(10) Pub. No.: US 2004/0124255 A1
(43) Pub. Date: Jul. 1, 2004

(54) Hot-melt equipment having internet connectivity and method of servicing and/or monitoring the same via the internet

(76) Inventor: Dieter Heerdt, Gallatin, TN (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/310,886

(22) Filed: Dec. 6, 2002

(51) Int. Cl. B67D 5/08

(52) U.S. Cl. 239/71

(57) ABSTRACT

Hot-melt equipment is provided with Internet as well as Intranet connectivity capabilities, resulting in numerous service, maintenance and cost efficiencies. The equipment is configured as a web server which contains web pages presenting an operational status of the equipment to a remote user, such as a vendor's technical support person, in a user-friendly format, such as HTML. The web pages allow the user to browse through numerous parameters of the equipment, and facilite remote control or trouble-shooting of the equipment. The hot-melt equipment is also provided with email capability to notify, by emails in human-readable form, a service center of a scheduled maintenace task or an abnormal operation mode of the equipment.

### TECHNICAL FIELD

The invention generally relates to hot-melt equipment, such as hot-melt machines and pattern controllers, accessible from remote locations such as over an Ethernet-based network or the Internet.

### BACKGROUND OF THE INVENTION

Various hot-melt systems are known in the art, including different types of equipment manufactured by ITW Dynatec, the assignees of the present invention. Such machines are used in various industrial applications like packaging, product assembly and non-woven manufacturing. Main components of hot-melt equipment include a melter with several heater zones, one or more pumps, heated supply hoses, applicator heads and an electronic controller to control the application process of a hot-melt material, such as glue, adhesive, plastic etc., on a substrate, which is usually carried by a moving conveyor belt. The hot-melt material, such as adhesive, in solid form is melted in the melter or hopper, and the one or more pumps supply the liquid hot-melt material via the supply hoses to the applicator heads. An electronic timing device, referred to as a pattern controller, controls the lay down of the hot-melt material on the desired position of the moving substrate in a desired pattern. After the temperature of the material drops below a predetermined point, the material solidifies or hardens.

Implementation of hot-melt equipment can vary from a simple system with a single hose and a single applicator head to complex systems with 12 or more hoses and/or applicator heads. Therefore, a hot-melt system can have 60 or more temperature zones. In order to provide maximum performance, the adjustment possibilities can be very large and extensive.

Many end customers require constant quality by monitoring significant parameters, and short downtime through quick installation and easy trouble shooting procedures. Therefore, the operator interface is an important issue on a hot-melt system.

Conventional hot-melt machines provide an operator interface via a display and a keyboard or keypad. Some manufacturer may provide a serial interface to communicate the hot-melt equipment with a parent machine controller. But all of these solutions are more or less proprietary and require special hardware and/or software. Installations require special knowledge and a significant amount of time.

Moreover, hot-melt equipment generally needs frequent maintenance and many customers require the possibility to monitor the status of the equipment. Traditionally, this has to be done on-site. That means the service technician has to physically go to the machine and check the parameters he wants to inspect. More and more companies prefer remote monitoring. Until now this has been accomplished via contact or 24VDC input/outputs which can be cost intensive and is not very flexible. An alternative is a serial communication. As mentioned in the foregoing section, this option requires special hardware and software, which is not standardized, and the distance between the machine and the remote technician or control terminal is limited.

### SUMMARY OF THE INVENTION

It is, therefore, an object of the present invention to provide a capability to remotely monitor and service hot-melt equipment via a network, such as an Ethernet-based network. Preferably, the hot-melt equipment is provided with Internet connectivity to allow access thereto over the Internet. Creating a communication interface between the hot-melt equipment and the Internet provides several advantages and features, including, but not limited to, world wide access, no special tools or knowledge required, flexible solution, real-time status and operational temperature checking, remote trouble shooting, quality control, automatic notification in case of critical situations.

It is another object of the present invention to provide a user-friendly interface, such as a web page, for allowing a user to remotely access the hot-melt equipment over the Internet. Preferably, all the user has to do is to simply start a standard browser program and enter the address of the hot-melt machine which will then appear as a web-server having all the typical control functions.

It is a further object of the present invention to provide a warning mechanism which automatically notifies the operator or a service center of the hot-melt equipment in case of critical situations. Preferably, the hot-melt equipment sends an email to a preprogrammed email address in such situations.

These and other objects of the present invention are achieved by a method of monitoring and/or controlling liquid dispensing equipment having an embedded electronic controller remotely accessible via a network. The liquid dispensing equipment comprises a liquid reservoir and an applicator head in liquid communication with the reservoir for receiving a liquid therefrom and controllably dispensing the liquid on a surface. The method comprises the steps of establishing a communication over the network between the electronic controller and a user at a remote terminal, and presenting to the user, by the electronic controller, a virtual user interface containing at least one of static and dynamic information about the liquid dispensing equipment.

In accordance with an aspect of the present invention, the electronic controller is configured to function as a network server in the network with the network server including a unique address recognizable in the network.

In accordance with another aspect of the present invention, the method further comprises locally monitoring a parameter of the liquid dispensing equipment by the electronic controller, and causing the electronic controller to send a message to a server corresponding to a maintenance or service center for one or more components of the liquid dispensing equipment, when a predetermined status of the parameter is detected during the monitoring.

The above and other objects of the present invention are also achieved by a device with network connectivity for dispensing a liquid on a surface. The device comprises liquid dispensing equipment, an electronic controller, and network hardware and software for providing the device with network connectivity. The liquid dispensing equipment comprises a liquid reservoir and an applicator head in liquid communication with the reservoir. The electronic controller is coupled to the liquid dispensing equipment for at least controlling application of the liquid, by the applicator head, on the surface. The network hardware communicates with the electronic controller and has a network connector for making connection to a network to which the device is to be connected. The network software, when being executed by the network hardware, configures the network hardware to be recognized and function as a network server in the network.

In accordance with an aspect of the present invention, the network server has a unique address recognizable in the network for allowing a user to access the network server by incorporating the unique address in a request sent to the network server.

In accordance with another aspect of the present invention, the network server further has an user interface, preferably interactive, containing at least one of static and dynamic information about the device, the user interface being presented to the user upon receiving the request.

In accordance with a further aspect of the present invention, the network server also has a message engine for generating and sending a message to a node in the network when a predetermined condition is detected in the device.

The above and other objects of the present invention are further achieved by hot-melt equipment with network connectivity, comprising a hot-melt section, an electronic controller, and network hardware and software for providing the hot-melt equipment with network connectivity. The hot-melt section comprising a melter for melting a material initially in solid form, a supply hose having an end in liquid communication with an outlet of the melter, and an applicator head in liquid communication with another end of the supply hose for receiving the melted material and controllably dispensing the melted material on a surface. The electronic controller is coupled to the hot-melt section for at least controlling application of the melted material in liquid form, by the applicator head, on the surface. The network hardware communicates with the electronic controller and has a network connector for making connection to a computer network to which the hot-melt equipment is to be connected. The network software, when being executed by the network hardware, configures the network hardware to be recognized and function as a network server in the computer network.

In accordance with an aspect of the present invention, the computer network comprises the Internet and the network server comprises a web server having a valid IP address.

In accordance with another aspect of the present invention, the web server includes at least one web page presenting a status of the hot-melt equipment in a user-friendly format, and the electronic controller is microprocessor-based and further comprises an Internet interface configured to translate data related to the status of the hot-melt equipment into the user-friendly format.

In accordance with a further aspect of the present invention, the web server further comprises an email engine configured to at least send emails via the Internet to pre-programmed email addresses. The emails are preferably sent in human-readable form, and the web server is further provided with an email codec (coder/decoder) configured to translate data obtained from the electronic controller into the human-readable form.

In a particularly preferred embodiment, a hot-melt system is provided with Ethernet/Internet connectivity. For this purpose, Ethernet/Internet hardware and software are included. The Ethernet/Internet hardware preferably includes a microcontroller communicating with the hot-melt system hardware and software. The microcontroller, which may consist of a single chip, is an embedded web server having a valid IP address. The chip may include Ethernet MAC and system controllers for, e.g., memory, DMA, interrupts and timers. The chip may also include cache, I/O, a real-time operating system, device driver software and communications protocol software. The hot-melt system may also include integrated networking software. The hot-melt system additionally stores one or more valid IP addresses of servers of centers providing maintenance or service for one or more components of the hot-melt system.

### BRIEF DESCRIPTION OF THE DRAWINGS

The present invention is illustrated by way of example, and not by limitation, in the figures of the accompanying drawings, wherein elements having the same reference numeral designations represent like elements throughout, and wherein:

FIG. 1 is a schematic view of the overall system set-up of a preferred embodiment of the present invention;

FIG. 2 is a schematic view of the hardware and software components of the electronic control section of hot-melt equipment according to one embodiment of the present invention; and

FIG. 3 is a schematic view of the hardware and software components of the electronic control section of hot-melt equipment according to another embodiment of the present invention.

### BEST MODE FOR CARRYING OUT THE INVENTION

Hot-melt equipment with Internet connectivity and a method of monitoring/controlling the hot-melt equipment via the Internet in accordance with the present invention are described. In the following detailed description, for purposes of explanation, numerous specific details are set forth in order to provide a thorough understanding of the present invention. It will be apparent, however, that the present invention may be practiced without these specific details. In other instances, well-known structures and devices are schematically shown in order to simplify the drawing.

The following terms are used throughout this description and in the appended claims, and are intended to have their broadest meaning consistent with the requirements of law. Where alternative meanings are possible, the broadest meaning is intended. All words used in the claims are intended to be used in the normal, customary usage of grammar and the English language.

“Chip” means an integrated microcircuit.

“Network hardware” means hardware used to provide a device with computer network connectivity. Likewise, “Internet hardware” means hardware used to provide a device with Internet/Ethernet connectivity.

“Network software” means software used to provide a device with computer network connectivity. Likewise, “Internet Software” means software used to provide a device with Internet/Ethernet connectivity.

“Valid network address” means an address that a computer network recognizes. Likewise, “valid IP address” means an address that the Internet and TCP/IP-based networks recognize.

“Microcontroller” means a miniaturized processor performing various functions, including that of a central processing unit.

“Hot-melt system” means any equipment used to melt, supply and apply a suitable material such as adhesive or glue.

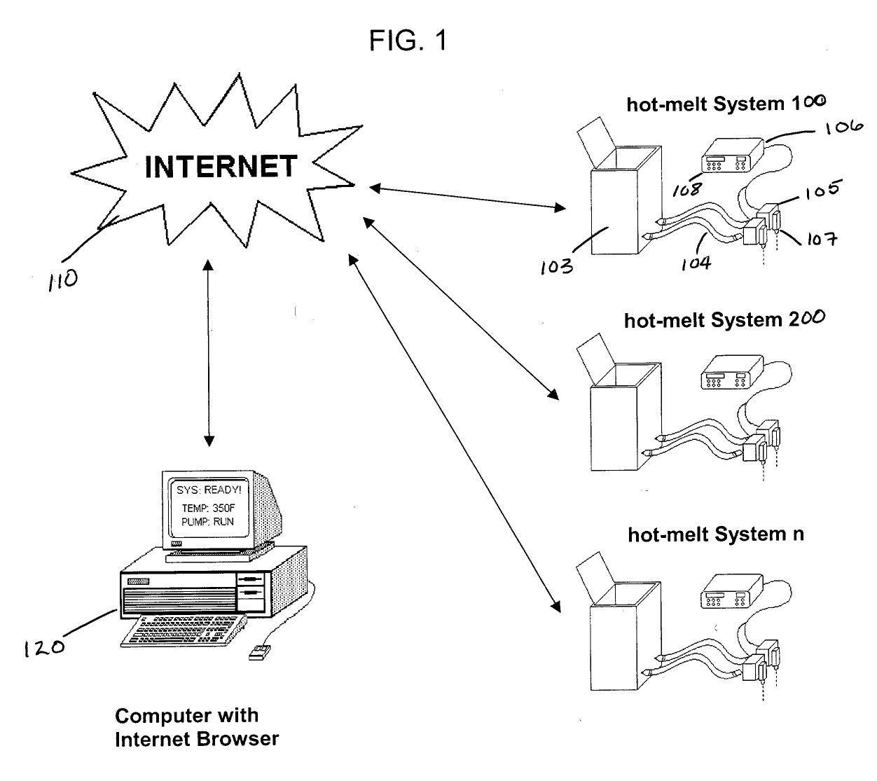

According to the present invention, as shown for example in FIG. 1, information may be remotely conveyed over the Internet between a remote user terminal and numerous hot-melt systems, using conventional web browsers such as Netscape® or Internet Explorer® which display web pages in the HTML language, for example. A widely used, local area network (LAN) technology known as the Ethernet may also be used for this purpose. A specific, preferred embodiment of such a system is now described.

Still referring to FIG. 1, in a preferred embodiment, hot-melt systems 100, 200, . . . n are connected to the Internet 110. A remote user terminal, designated at 120, communicates with the hot-melt systems via the Internet in the manner described herein below. In most cases, hot-melt systems 100, 200 etc. are connected to a LAN or WAN while remote terminal 120 belongs to another WAN or LAN which, in turn, is connected to the LAN/WAN of the hot-melt systems via an Intranet or the Internet. Gateways (not shown) may be needed to make these connections.

Each hot-melt system typically includes a hot-melt section and electronic controller 106. The hot-melt section includes melter 103 communicated with applicator heads 105 via supply hoses 104. Each applicator head 105 has a plurality of nozzles 107 from which material in liquid form, such as melted adhesive or glue, is dispensed on a substrate (not shown). Electronic controller 106 is coupled to at least applicator heads 105 to control the amount of material and the pattern and timing in accordance with which the material is to be dispensed on a surface of the substrate. Each electronic controller 106 includes control panel, or physical user interface, 108 via which the operator of the hot-melt system operates or monitors an operational status of the hot-melt system. There is also included a driving mechanism (not shown) for moving applicator heads 105 relatively to the substrate.

Skilled artisans will easily recognize that hot-melt systems of other configurations can also be used in the present invention. For example, there may be a single supply hose 104 which feeds the melted material from melter 103 to a manifold (not shown) which is common for numerous applicator heads 105. Supply hoses 104 are usually heated to maintain the melted material at proper temperature or viscosity. Heating of supply hoses 104 also prevents the melted material from solidifying during its transfer which, in turn, may choke up the supply hoses. For the same reasons, applicator heads 105 may include one or more heaters. Melter 103 may also have several heated zones of different temperatures for, e.g., supplying the melted material in different states for different applications. Electronic controller 106 can be connected not only to applicator heads 105 but also to melter 103 and supply hoses 104 to monitor and/or regulate, e.g., the material temperatures in these components. If the melted material is forced to flow from melter 103 to supply hoses 104 by, e.g., pumps (not shown), electronic controller 106 can also be connected to the pumps to monitor and/or regulate their pumping speeds.

The above-described configurations are typical for hot-melt systems, and are described in more details in, e.g., U.S. Pat. Nos. 6,371,174, 6,215,109, 6,168,049, 5,934,562, 5,882,573, 5,823,437, the entireties thereof are incorporated herein by reference.

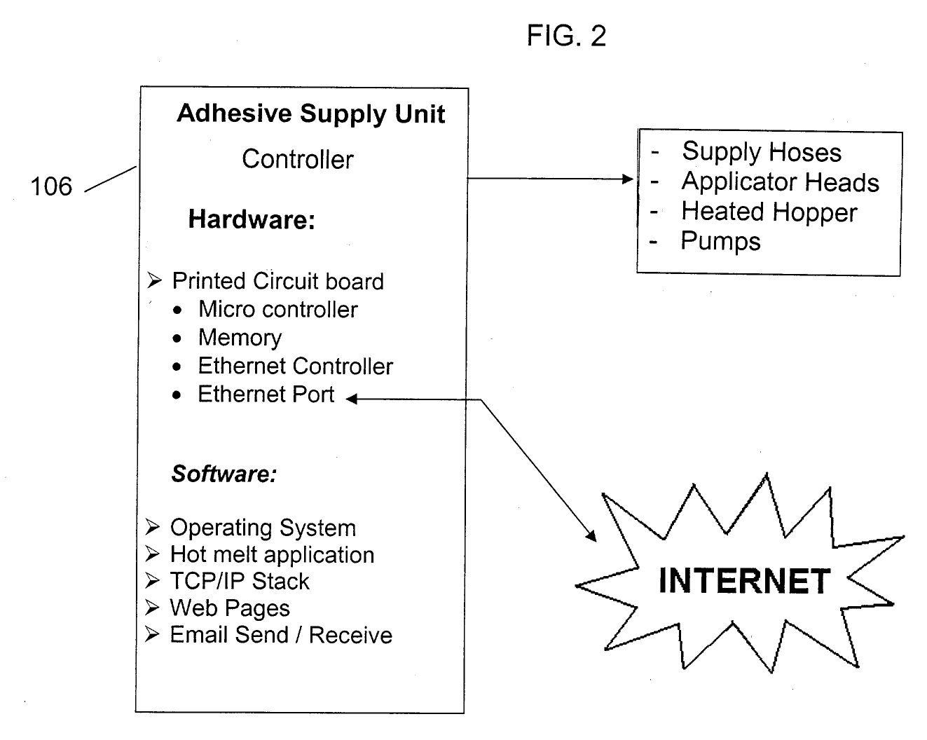

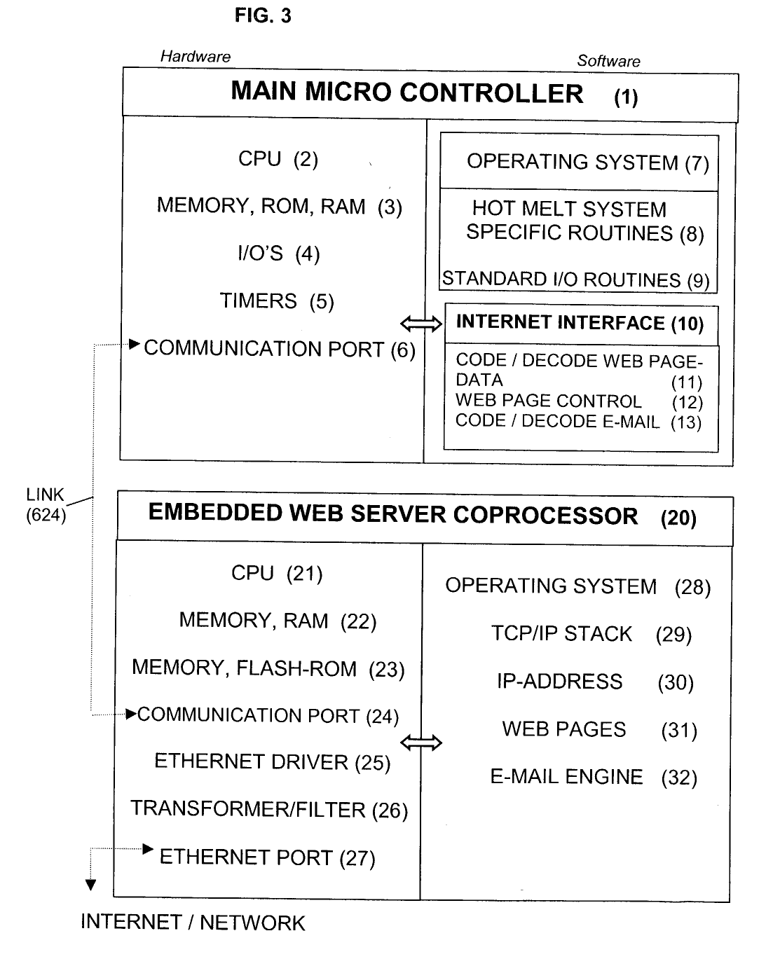

Referring now to FIG. 2, a schematic view of the hardware and software components of electronic controller 106 according to the present invention is shown. The hardware portion of electronic controller 106 is preferably built on a printed circuit board which includes a microcontroller, a memory, and network hardware. The network hardware includes a network controller, such as an Ethernet controller, and an associated network (Ethernet) port. The software portion of electronic controller 106 preferably includes an operating system, a specific application for controlling the hot-melt section of the system, and network software. In a preferred embodiment, the network software is Internet software, and includes a TCP/IP stack, web pages and an email engine. Preferably, the software section of electronic controller 106 resides in the memory of the hardware section, and is executed by the microcontroller. In the embodiment shown in FIG. 2, both hot-melt application software and network software, running preferably in the same operating system, are loaded in a single hardware configuration arranged to both control operation of the hot-melt section and connect to an external network, such as the Internet. The microcontroller and memory, as well as other components such as timers, address and data buses, I/Os, interrupts etc. are integrated on a single printed circuit board, and used to run both the hot-melt application software and network software. However, there are also other possible arrangements in which electronic controller 106 is divided either partly or completely into two sections each intended to perform one of the above functions. An example is illustrated in FIG. 3.

Electronic controller 106 of the preferred embodiment depicted in FIG. 3 contains two basic sections. The first section is main microcontroller 1. The hardware part of microcontroller 1 contains CPU 2, memory 3, I/Os 4 used for controlling specific features of the hot-melt section, timers 5 for real-time functions, and communication port 6. The software part of microcontroller 1 contains operating system 7 and Internet interface 10. The software part resides in memory 3, which is ROM, RAM, PROM, EPROM, FLASH-EPROM, or any other dynamic storage device, and is executed by microcontroller 1. Operating system 7 has standard functions such as hot-melt system specific routines 8 and standard I/O routines 9. Hot-melt system specific routines 8 control operation of the hot-melt section in accordance with preprogrammed or user-specified commands. The commands are transmitted, using standard I/O routines 9 and via I/Os 4, to the hot-melt section (not shown in FIG. 3) for implementation. Functions of Internet interface 10 will be described herein below in conjunction with the second section of electronic controller 106 which is embedded web server coprocessor 20.

The hardware part of embedded web server coprocessor 20 contains its own CPU 21, memory modules 22, 23 and communication port 24 corresponding to communication port 6 of microcontroller 1. The hardware part of embedded web server coprocessor 20 further includes a network interface for making connection with an external network, such as the Internet. The network interface is physically built with network connector or port 27, driver 25 for network port 27, and optionally a transformer/filter 26. If the Ethernet standard is used, network port 27 and driver 25 will be Ethernet port and Ethernet driver, respectively. Driver 25 and transformer/filter 26 can be implemented otherwise, i.e., as pieces of software. The software part of embedded web server coprocessor 20 includes its own operating system 28, and network software which, in this particular embodiment, is Internet software. As described with respect to FIG. 2, the Internet software includes TCP/IP stack 29, web page or web pages 31, and email engine 32. Functions of the Internet software will be described herein below in conjunction with Internet interface 10 of main microcontroller 1.

In a preferred embodiment, in order to provide Internet connectivity to the hot-melt system, embedded web server coprocessor 20 may use an Ethernet microprocessor, such as the NET+ARM™ available from NetSilicon. This Ethernet processor integrates a 32-bit ARMY processor, Ethernet MAC, DMA controllers, I/O, timers, etc., onto a single chip. The operating system and all of the network software, protocols and services are also integrated onto the chip. This chip is “embedded” into electronic controller 106 using known techniques, allowing the electronic controller to connect to the network via Ethernet, thereby providing Ethernet and Internet connectivity for the hot-melt system. Once connected, the hot-melt system may be managed, serviced and accessed from any site supporting Internet access.

Main microcontroller 1 and embedded web server coprocessor 20 are communicated via respective communication ports 6 and 24 and link 624. The communication ports and link 624 can be of any type known in the art. For example, link 624 can be buses (data and address buses) implemented as a flexible cable connecting communication ports 6 and 24 which, in turn, are compatible cable connectors. Link 624 can alternatively be implemented as conductive traces running in or on a printed circuit board which accommodates main microcontroller 1 and embedded web server coprocessor 20. It is within the scope of the present invention to make link 624 optical or wireless. Link 624 may be omitted if, for example, the printed circuit board of embedded web server coprocessor 20 is arranged to plug in the printed circuit board of main microcontroller 1 like a daughter board plugs in an expansion slot of a mother board. The latest configuration makes it very easy to implement the present invention in existing hot-melt equipment with quick and simple installation.

CPU 21 runs operating system 28 which coordinates data flows from and to main micro controller 1 and data flows from and to the Internet or Intranet. The data exchange between CPU 21 and operating system 28 of embedded web server coprocessor 20 and the Internet or Intranet is carried out mostly in the manner known in the art, and will not be described in detail herein for the sake of simplicity. Internet interface 10 of main microcontroller 1 uses communication port 6 to communicate to the Internet software of embedded web server coprocessor 20.

When this preferred system is connected to a TCP/IP-based network (Internet/Intranet), a user can remotely access the hot-melt system using a terminal such as a standard PC running a commonly available Internet browser. In order to identify the hot-melt system, a unique network or IP address 30 is necessary. IP address 30 is preferably permanent and can be either logically assigned or physically embedded in the hardware portion of embedded web server coprocessor 20 in a known manner. By entering this IP-address in the browser, the user at the remote terminal will access web pages 31 located inside the hot-melt system. Through Internet interface 10, communication ports 6, 24, link 624, port 27, and the Internet software of embedded web server coprocessor 20, main micro controller 1 can exchange data with the user.

In other words, the hot-melt system, when the Internet software is executed by CPU 21, will be configured as a network server. If the network is the Internet, the hot-melt system will be configured as a web server. If the Web server is used internally and not by the public, it can be regarded as an intranet server. In this preferred embodiment, the web server is a HTTP server that manages Web page requests from the browser and delivers HTML documents, or web pages 31, in response. The web server also executes server-side scripts (CGT scripts, JSPs, ASPs, etc.) that provide additional functions such as searching.

In this preferred embodiment, the HTTP server and web pages 31 are the means for configuring/controlling/monitoring the hot-melt system. Web pages 31 contain information about the hot-melt system in general, and the hot-melt section in particular. The information presented in web pages 31 includes an operational status of the hot-melt system in form of static and dynamic information. Examples of static information are, but not limited to, machine properties that do not change while the machine is running. These properties could be system configuration or technical specifications. Although these are fixed properties of an existing machine, it is useful to show them on the web page. Examples of dynamic information are, but not limited to, temperatures in various zones throughout the hot-melt section, hot-melt pumping speeds, dispensing patterns, etc. Typical controls in a hot-melt system are controlling (that means setting, measuring and maintaining) temperature, motor speed, adhesive pressure and adhesive application. These dynamic parameters are monitored by sensors in known manners, e.g., in real time or periodically. However, unlike the preexisting system in which detected values of the monitored parameters are fed to a physical, local control panel or interface, the detected values in the present invention are translated and presented in web pages 31 which can be considered as a virtual control panel or user interface. The present invention does not exclude the preexisting control panel. Thus, the detected values can be presented in both physical and virtual control panels.

Internet interface 10 of main microcontroller 1 serves as a buffer between the sensors and web pages 31. In particular, raw data supplied from the sensors is processed by data coding/decoding section 11 of Internet interface 10 which decodes the data for presentation in web pages 31. Likewise, when control commands sent by a remote user are transferred to Internet interface 10 through the Internet software of embedded web server coprocessor 20, data coding/decoding section 11 translates the commands into machine readable form and forwards the translated commands, via CPU 2 and I/Os 4, to the hot-melt section for implementation, e.g., effecting a new value for a monitored parameter. For this purpose, web pages or user interface 31 presents a number of optional commands for selection by the user. Commands can also be keyed in, by the user, using predetermined syntax, in a command prompt line also provided in web pages 31. Execution of the selected or entered commands by main microcontroller 1 causes the hot-melt section to change its operational mode. The commands may also activate a new monitoring/controlling mode, i.e., by requiring a new set of sensors, which have not been working or sending data in the previous monitoring/controlling mode, to collect and send data to main microcontroller 1 and then to web pages 31. This “new” monitoring/controlling mode is called user-specified and used mostly in critical situations when additional, comprehensive insight into the operation of the hot-melt system is needed. In other words, the web pages or virtual control panel/user interface are interactive, making it possible to both monitor and manipulate various parameters of the hot-melt system.

Internet interface 10 further includes web page control routine 12 which controls navigation within a web page 31 or among multiple web pages 31.

The physical residence of one or more parts of Internet interface 10 can also be arranged in embedded web server coprocessor 20 instead of main microcontroller 1. Likewise, the Internet software can reside in main microcontroller 1 rather than in embedded web server coprocessor 20. A preferred configuration is shown in FIG. 3. In another preferred embodiment, the entirety of Internet interface 10 is located in embedded web server coprocessor 20. In this configuration, main microcontroller 1 is similar to known electronic controllers. The network or Internet connectivity of the hot-melt system is entirely provided by embedded web server coprocessor 20, which includes, besides operating system 28, TCP/IP task 29, IP address 30, and web pages 31, Internet interface 10. This embodiment is particularly useful when it is needed to upgrade a preexisting electronic controller to have Internet connectivity. The upgrade process can be simply done by, e.g., plugging in a daughter board accommodating embedded web server coprocessor 20 with the Internet software and Internet interface 10 embedded therein in an expansion slot on a mother board accommodating main microcontroller 1. The hot-melt system will then be Internet-ready immediately.

Another functionality of this invention is the sending and receiving of e-mails. The main microcontroller 1 can, depending on the status of the hot-melt equipment, automatically send an email to any valid email address. An example would be to inform the maintenance personal about a critical situation in the hot-melt system. Another example is to notify the maintenance personal of a scheduled maintenance task. In both cases, electronic controller 106 needs email engine 32. Email engine 32 is sufficiently an email client or email reader or email program that can access the mail servers in a local or remote network. Also known as a “mail client,” “mail program,” and “mail reader,” email engine 32 provides the ability to send and receive e-mail messages and/or file attachments. E-mail capability may be built into the Internet software. A light version of a stand-alone program, such as Outlook and Eudora, can also be used. Although it is sufficient in the context of the present invention to configure email engine 32 as an email client, email engine 32 can be configured as an email server to server as a post office for numerous hot-melt systems connected in the same local network. This eliminates the need for a dedicated mail server, such as a personal computer, in the network of the hot-melt systems.

Similar to web pages 31, email engine 32 needs a coding/decoding section, such as email coding/decoding section 13, that resides preferably in Internet interface 10. However, as discussed above, the physical residences of email engine 32 as well as email coding/decoding section 13 are interchangeable between embedded web server coprocessor 20 and main microcontroller 1. Email coding/decoding section 13 extracts user-specified commands from received emails, translates the extracted commands into machine-readable form, and forwards the translated commands, via CPU 2 and I/Os 4, to the hot-melt section for implementation. Email coding/decoding section 13 also composes emails to be sent out, via email engine 32, upon detecting a predetermined condition in the hot-melt system, e.g., an abnormal operational mode of the hot-melt section.

The emails may or may not include parameters presenting the current condition of the hot-melt system. It is also within the scope of the present invention that emails sent by email engine 32 are composed in human-readable form. However, it is not excluded that the emails contains only some predefined codes which will be deciphered at the other end, by the recipient. Moreover, the emails are sent to preprogrammed email addresses which are addresses of servers corresponding to a service or maintenance center, e.g., for one or more components of the hot-melt equipment. Thus, when the hot-melt system is malfunctioning or if a scheduled maintenance task is due, the vendor or a technical support providing firm will be promptly notified. Likewise, when human interference, e.g., by the local operator, is required, he or she will receive an email from the hot-melt system that needs to be serviced. Although, it has been described that email engine 32 generates and sends emails on an event-triggered basis, periodical or user-requested emails can be sent as well to provide daily, weekly, monthly or real-time reports on operation of the hot-melt system.

It should now be understood that the present invention provides hot-melt equipment with Internet connectivity by configuring the electronic controller of the hot-melt equipment as an embedded web server with its own unique IP address. The Internet connectivity of the hot-melt equipment of the present invention permits access from, for example, an Internet browser, which results in a number of advantages. For example, the status of the hot-melt equipment can be remotely monitored by a terminal or server operated by service or manufacturing personnel, for example. Commands can be sent by the servicing server, and e-mail alerts to or from the embedded web server on the hot-melt equipment may be sent or received. The resulting remote control and remote diagnostic capabilities provide a host of advantages, such as the ability to automatically reorder supplies such as the hot-melt material in solid form when needed, the ability to order hot-melt component replacement, gathering and reporting statistics, e.g., on hot-melt equipment usage, and scheduling maintenance as required.

Two-way communication is provided, of course, such that service personnel, after being notified by the hot-melt equipment of the need for maintenance, for example, could then notify the consumer or local operator of a scheduled service call in advance of that call, or to confirm an order. This notification could occur by fax or by email, for example, since the service server would know the valid IP address of the customer corresponding to that hot-melt equipment. Software at the servicing server could also be provided which automatically updates either or both of the hot-melt application and Internet software. The current software versions of the hot-melt system are either checked by the software at the servicing server or reported out by the Internet software and email engine 32 on a regular basis. A remote user can also check, in real time, the software versions on web pages 31, and manually specifies whether the hot-melt system's software needs updating or not. If upgrade is required, a newer version of the hot-melt application and/or Internet software will be pushed or downloaded to the web server to be installed thereon. Alternatively, the newer version can be attached to an email sent to email engine 32, and then automatically or manually detached and installed.

Hot-melt equipment can also monitor and gather data on use and performance history and usage requirements, and report this information to the manufacturer, service personnel, or others. Hot-melt equipment may also access data from other devices also connected to the Internet, or control or be controlled by such devices, for these and other purposes. Of course, the advantage of a constant communication connection is also provided, as well as communication with both Intranet and Internet sources and connected devices.

Typical features of the present invention are remote monitoring of the status of the hot-melt equipment (e.g. temperatures of heater zones), remote trouble shooting or remote controlling by sending commands or data via web page to the hot-melt unit. The trouble shooting feature allows a user, who is, for example, a technical support person of the hot-melt system vendor, to remotely fix or help the local operator to fix the hot-melt equipment, without having to physically arrive at the site. For example, the hot-melt machine is producing sporadically alarm messages. Via remote trouble-shooting, a service person can check all temperature zones, read out an error logbook, and initiate counter measures like changing PID-loop parameters or temperature tolerance.

The above description is not intended to limit the meaning of the words used in the following claims that define the invention. For example, it will be easily recognized that the principles of the present invention are applicable to any device which is arranged to dispense a liquid on a surface as long as such a device has a reservoir in communication with an applicator head controlled by an electronic controller. An example includes, but is not limited to, industrial or stand-alone inkjet printers. Further, the web server may be provided with some levels of security which screen out strangers or unauthorized users, and categorize authorized users into several groups with various privileges. For example, users from one group can only observe or monitor the operation of the hot-melt system, while users from another group are additionally provided with partial or full control of the equipment. Security can be implemented in any manner known in the art, e.g., using passwords. Therefore, it is contemplated that future modifications in structure, function or result will exist that are not substantial changes and that all such insubstantial changes in what is claimed are intended to be covered by the appended claims.

What is claimed:

1. A device with network connectivity for dispensing a liquid on a surface, comprising:
liquid dispensing equipment comprising a liquid reservoir and an applicator head in liquid communication with said reservoir;
an electronic controller coupled to said liquid dispensing equipment for at least controlling application of the liquid, by said applicator head, on the surface; and
network hardware and software for providing said device with network connectivity, said network hardware communicating with said electronic controller and having a network connector for making connection to a network to which said device is to be connected, and said network software, when being executed by said network hardware, configuring said network hardware to be recognized and function as a network server in the network.

2. The device of claim 1, wherein said network server has a unique address recognizable in the network for allowing a user to access said network server by incorporating said unique address in a request sent to said network server.

3. The device of claim 2, wherein said network server has a virtual user interface containing at least one of static and dynamic information about said device, said user interface being presented to the user upon receiving the request.

4. The device of claim 3, wherein said dynamic information is obtained from said electronic controller and includes an operational status of said liquid dispensing equipment.

5. The device of claim 3, wherein said static information includes at least one of (i) a configuration of said liquid dispensing equipment and (ii) parameters of said liquid dispensing equipment that do not change while said liquid dispensing equipment is running to dispense said liquid on the surface.

6. The device of claim 3, wherein said user interface is interactive and includes a plurality of commands for selection by the user, said network server, upon execution of a selected command, causing said electronic controller to change a working parameter of said liquid dispensing equipment.

7. The device of claim 3, wherein said user interface is interactive and includes a command line for receiving a command keyed in by the user, said network server, upon execution of the keyed-in command, causing said electronic controller to change a working parameter of said liquid dispensing equipment.

8. The device of claim 1, wherein said network server has a messaging program for generating and sending a message to a node in the network when a predetermined condition is detected in said device.

9. The device of claim 1, wherein said messaging program includes addresses of servers corresponding to maintenance or service centers for one or more components of said liquid dispensing equipment.

10. A method of monitoring and/or controlling liquid dispensing equipment having an embedded electronic controller remotely accessible via a network, said liquid dispensing equipment comprising a liquid reservoir and an applicator head in liquid communication with said reservoir for receiving a liquid therefrom and controllably dispensing the liquid on a surface, said method comprising the steps of:
establishing a communication over the network between the electronic controller and a user at a remote terminal; and
presenting to the user, by the electronic controller, a virtual user interface containing at least one of static and dynamic information about said liquid dispensing equipment.

11. The method of claim 10, further comprising configuring the electronic controller to function as a network server in the network, said network server including a unique address recognizable in the network.

12. The method of claim 11, further comprising selecting or entering, by the user and via said user interface, a command to be executed by said electronic controller to change an operational mode of said liquid dispensing equipment.

13. The method of claim 11, further comprising locally monitoring a parameter of the liquid dispensing equipment by the electronic controller.

14. The method of claim 13, further comprising sending, by said electronic controller, a message to a server corresponding to a maintenance or service center for one or more components of said liquid dispensing equipment, when a predetermined status of said parameter is detected during said monitoring.

15. The method of claim 14, wherein said predetermined status is related either to an abnormal operational mode or a scheduled maintenance task of said liquid dispensing equipment.

16. The method of claim 13, wherein said monitoring comprises one of real time, periodic, and user-specified.

17. The method of claim 13, wherein said parameter comprises at least one of adhesive temperature, adhesive pressure, adhesive lay-down pattern, and motor speed of said liquid dispensing equipment.

18. The method of claim 13, further comprising presenting a status of said parameter as detected in said monitoring in the user interface, and dynamically updating the status of said parameter.

19. The method of claim 11, further comprising causing a software section of said electronic controller to be updated with a newer version downloaded directly from the network to said electronic controller.

20. The method of claim 11, wherein the electronic controller and the user's remote terminal are connected to two different LANs or WANs which, in turn, are connected with each other via a TCP/IP-based network.

21. Hot-melt equipment with network connectivity, comprising:
a hot-melt section comprising a melter for melting a material initially in solid form, a supply hose having an end in liquid communication with an outlet of said melter, and an applicator head in liquid communication with another end of said supply hose for receiving the melted material and controllably dispensing the melted material on a surface;
an electronic controller coupled to said hot-melt section for at least controlling application of the melted material in liquid form, by said applicator head, on the surface; and
network hardware and software for providing said hot-melt equipment with network connectivity, said network hardware communicating with said electronic controller and having a network connector for making connection to a computer network to which said hot-melt equipment is to be connected, and said network software, when being executed by said network hardware, configuring said network hardware to be recognized and function as a network server in the computer network.

22. The hot-melt equipment of claim 21, wherein the computer network comprises the Internet and the network server comprises a web server having a valid IP address.

23. The hot-melt equipment of claim 22, wherein said IP address is permanent.

24. The hot-melt equipment of claim 22, wherein said IP address is logically assigned to said network software.

25. The hot-melt equipment of claim 22, wherein said IP address is physically built in said network hardware.

26. The hot-melt equipment of claim 22, wherein said network software stores one or more valid IP addresses of servers corresponding to maintenance or service centers for one or more components of said hot-melt equipment.

27. The hot-melt equipment of claim 22, wherein said electronic controller comprises a first microprocessor coupled to first timers and a first memory storing a first operating system.

28. The hot-melt equipment of claim 27, wherein said first operating system includes specific routines for controlling operation of said hot-melt section.

29. The hot-melt equipment of claim 27, wherein said web server includes at least one web page presenting a status of said hot-melt equipment in a user-friendly format, said electronic controller further comprising an Internet interface configured to translate data related to the status of said hot-melt equipment into the user-friendly format.

30. The hot-melt equipment of claim 29, wherein said Internet interface further comprises a web page navigation control for enabling a user to navigate within said web page and/or among a plurality of said web pages.

31. The hot-melt equipment of claim 27, wherein said network hardware further comprises a second microprocessor coupled to second timers and a second memory.

32. The hot-melt equipment of claim 31, wherein said network software comprises a second operating system stored in the second memory, said valid IP address, and at least one web page presenting a status of said hot-melt equipment in a user-friendly format.

33. The hot-melt equipment of claim 32, wherein said network software further comprises an email engine configured to at least send emails via the Internet to pre-programmed email addresses.

34. The hot-melt equipment of claim 33, wherein said web server further comprises an email codec configured to code or decode information sent to or received from said email engine, respectively.

35. The hot-melt equipment of claim 34, wherein said emails are sent in human-readable form, and said email codec is configured to translate data obtained from said electronic controller into the human-readable form.

36. The hot-melt equipment of claim 33, wherein said electronic controller is configured to monitor at least one parameter of said hot-melt section and trigger said email engine to send at least one of said emails when a predetermined status of said parameter is detected.
